(19) United States
(12) Patent Application Publication
(10) Pub. No.: US 2019/0259288 A1
(43) Pub. Date: Aug. 22, 2019

(54) DEVELOPMENT TESTING DEVICE

(71) Applicant: Oleh Serhiyenko, Edmonton (CA)

(72) Inventor: Oleh Serhiyenko, Edmonton (CA)

(21) Appl. No.: 15/898,428

(22) Filed: Feb. 17, 2018

(51) Int. Cl. G09B 1/06; A63F 9/06

(52) U.S. Cl. CPC G09B 1/06; A63F 2009/0668; A63F 9/0666

(57) ABSTRACT

A device for testing cognitive development of a user; the device includes a housing and a test-member. Further, in a preferred embodiment, the device includes a cover-portion and a plurality of test-blocks. The device is useful for testing the cognitive development of the user by providing a revolving-test member including a plurality of test-displays each having a different development topic for testing.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of development testing and more specifically relates to a cognitive development testing device including a plurality of test-displays.

### 2. DESCRIPTION OF RELATED ART

A number of studies indicate that individuals have several learning channels which may be considered discrete and relatively independent from each other. Sounds, letters, shapes, designs, rhythm, and non-associative memory are the most easily identifiable and have the longest history of being formally measured.

Shape-sorting toys have been classic toddler favorites for many years and are still one of the most popular types of toys available today. Toddlers learn about shapes and develop manual dexterity by dropping geometric blocks through matching apertures. This activity is beneficial to toddlers by helping them to understand spatial concepts, to develop problem-solving skills and to practice hand-eye coordination.

However, many of these toys fail to keep the interest of children often because they lack sufficient visual or audio stimuli. Children's short attention spans often render such toys obsolete as failed attempts, produce frustration, or as repeated successes produce boredom. Thus, a suitable solution is desired.

U.S. Pat. No. 4,286,952 to Mary E. Roche relates to an educational toy. The described educational toy includes an open top rectangular box having a plurality of like bottom sockets in a spaced apart relationship in its bottom and a truncated corner post at each interior corner, a plurality of rectilinear platform blocks of different heights each of which is provided with a mounting post that extends from and perpendicular to the bottom thereof and which post is adapted to be removably inserted into any bottom socket, a color board adapted to be removably placed in the top of the box and to sit on the truncated corner posts and having a plurality of distinctively colored figures equal in number to the number of bottom sockets painted or otherwise provided on one surface thereof in a spaced apart relationship.

### BRIEF SUMMARY OF THE INVENTION

In view of the foregoing disadvantages inherent in the known development testing art, the present disclosure provides a novel development testing device. The general purpose of the present disclosure, which will be described subsequently in greater detail, is to provide a device for testing cognitive development in children and adults.

A device is disclosed herein. The device includes a housing which may include an inner-capacity and an outer-shell (defining the inner-capacity) having a substantially open-portion; and a test-member disposed within the inner-capacity of the housing and hingedly-connected to the housing. The test-member may include at least two test-displays opposite each other, one of the at least two test-displays may include a first development topic and another one of the at least two test-displays may include a second development topic. Further, the test-member may be configured to selectively revolve between the at least two test-displays such that the user may view a selected test-display through the substantially open-portion.

A method of using device is also disclosed herein. The method of using device may comprise the steps of: providing the device as above; selectively revolving the test-member to view one of the at least two test-displays, the one of the at least two test-displays may include one of the first development topic and the second development topic; testing the user on the one of the first development topic and the second development topic; and recording a result of the test.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a development testing device, constructed and operative according to the teachings of the present disclosure.

FIG. 1 is a side perspective view of the device during an ‘in-use’ condition, according to an embodiment of the disclosure.

FIG. 2 is a side perspective view of the device of FIG. 1, according to an embodiment of the present disclosure.

FIG. 3 is a front perspective view of the device of FIG. 1, according to an embodiment of the present disclosure.

FIG. 4 is a front perspective view of the device of FIG. 1, according to an embodiment of the present disclosure.

FIG. 5 is a view of a checklist for use with the device, according to an embodiment of the present disclosure.

FIG. 6 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a development testing and more particularly to a development testing device as used to improve the cognitive development testing device including a plurality of test-displays.

Generally disclosed is a device which may help to provide a development evaluation for babies (ages 2-5) and older and people who have suffered physical brain damage or psychological trauma. The reason for the evaluation may be to understand the right level of development prior or at the beginning of attending kindergarten or preschool for kids; and rehabilitation course for adults who may start an education from a bottom level again after the trauma or accident.

The device may require a person who is trained to use the test device (the tester), the device (DTD 100) and a testable person (the testable). The device may be a box shape and may include a revolving piece inside entitled “STARDRUM”. To start, the tester may slide a cover on the device up and out and set stardrum to start or any panel position by pushing down on a bottom panel.

During the test, the tester may change the stardrum position to different topics. Topics may include: colors; shapes; digits; flora and fauna; household and the like. Before the next topic can be used, the tester may eject test pieces from the vertical plate of the stardrum. To eject the test pieces from stardrum, the DTD 100 may be tilted right and 10 test pieces for each topic may exit out of the stardrum through an extraction hole. The extraction hole may be sized to allow penetration with finger the tester's finger aid in test piece extraction. After extraction the test pieces may be placed back onto the bottom plate.

The testable may provide simple, basic but wide knowledge about the surrounding world by taking test pieces from a bottom plate and dropping them to correct holes of a vertical plate for each of 5 topics accordingly. For example, if testable (testee) picks up a brown test piece on the colors topic and calls it “brown” he/she may receive 1 point. If testable determines the correct color hole on the vertical plate, and drops the test piece to it, he/she may receive a second point. For further panels shapes; digits; flora and fauna; and household; instead of colors, there may certain shape pieces for topics. For example, if testable picks diamond on the shapes topic and calls it a “diamond” he/she may receive 1 point. Similarly, as above, if the testable determines the correct shape hole on the vertical plate and drops the test piece to it, he/she may receive one more point. If testable picks up a piece, does not know the name but drops it into correct hole on the vertical plate, he/she may receive one point as this may mean that in spite of the testable not knowing the correct name, the brain part helped find proper shape/configuration on the horizontal plate which indicates cognitive ability.

The test may include a check sheet (DTD check sheet) for the tester to use. During the test, the tester may make certain check marks for the testable person test results on the DTD check sheet. The results on the check sheet may be calculated and analyzed during further evaluation. The check sheet may help the tester digitize the results for determination of further educational steps. The evaluation may help diagnose diseases like Daltonism, Autism, and etc., (consulting with medical specialist(s) is recommended for maximizing diagnostic results); determine right/left brain involvement, and the determination may help to correct further education processes.

During the test, the testable may be located in front of the DTD 100, and the tester may sit on a right side of the testable. The tester's left hand may hold a right side of the DTD 100 and right hand may add check marks to the DTD check sheet.

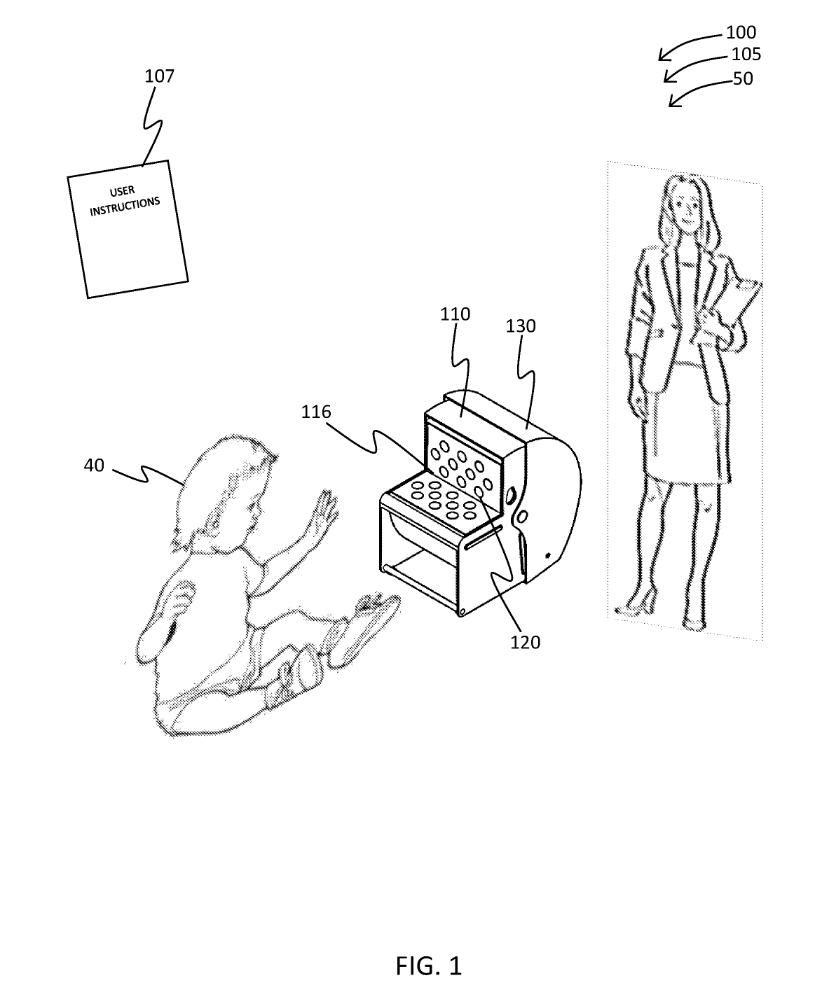

Referring now more specifically to the drawings by numerals of reference, there is shown in FIGS. 1-4, various views of a device 100.

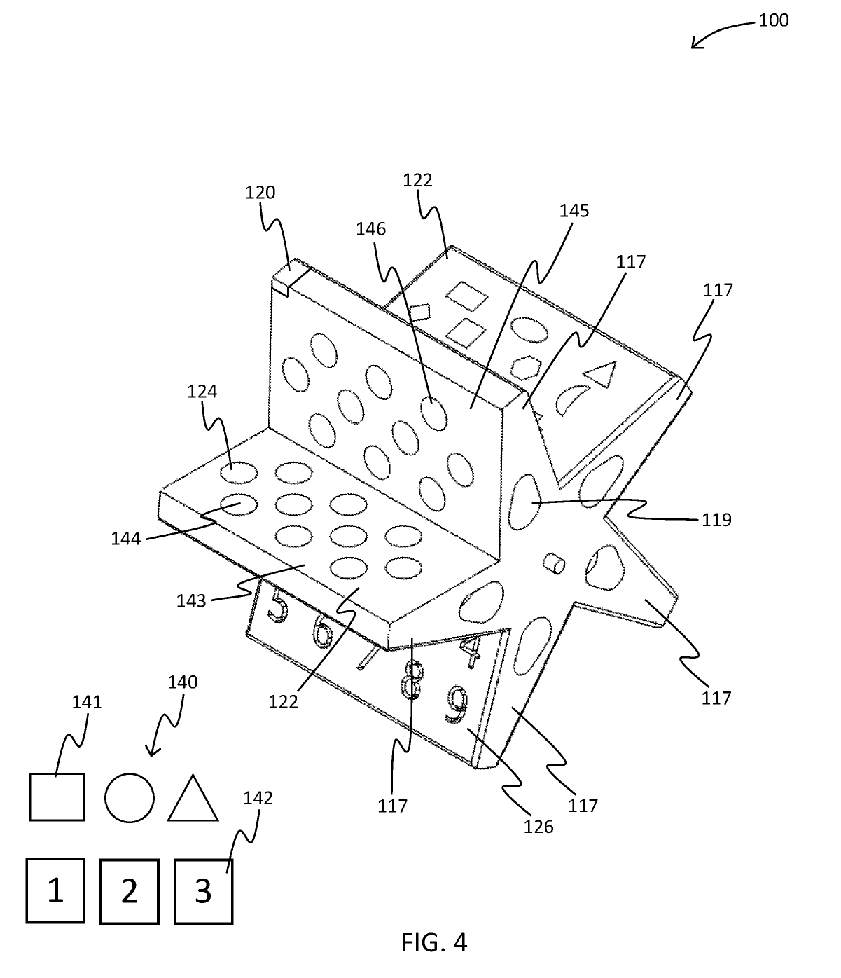

FIG. 1 shows a device 100 during an ‘in-use’ condition 150, according to an embodiment of the present disclosure. As illustrated, the device 100 may include a housing 110 and a test-member 120. In a preferred embodiment, the device 100 may further include a cover-portion 130 and a plurality of test-blocks 140 (FIG. 4). As shown, the device 100 may be used for testing cognitive development of a user 40. In this figure, the user 40 is shown to be an infant. However, it should be appreciated that the device 100 may be used to test users 40 of all ages.

According to one embodiment, the device 100 may be arranged as a kit 105. The kit 105 may include a set of user instructions 107. The instructions 107 may detail functional relationships in relation to the structure of the device 100 (such that the device 100 can be used, maintained, or the like, in a preferred manner).

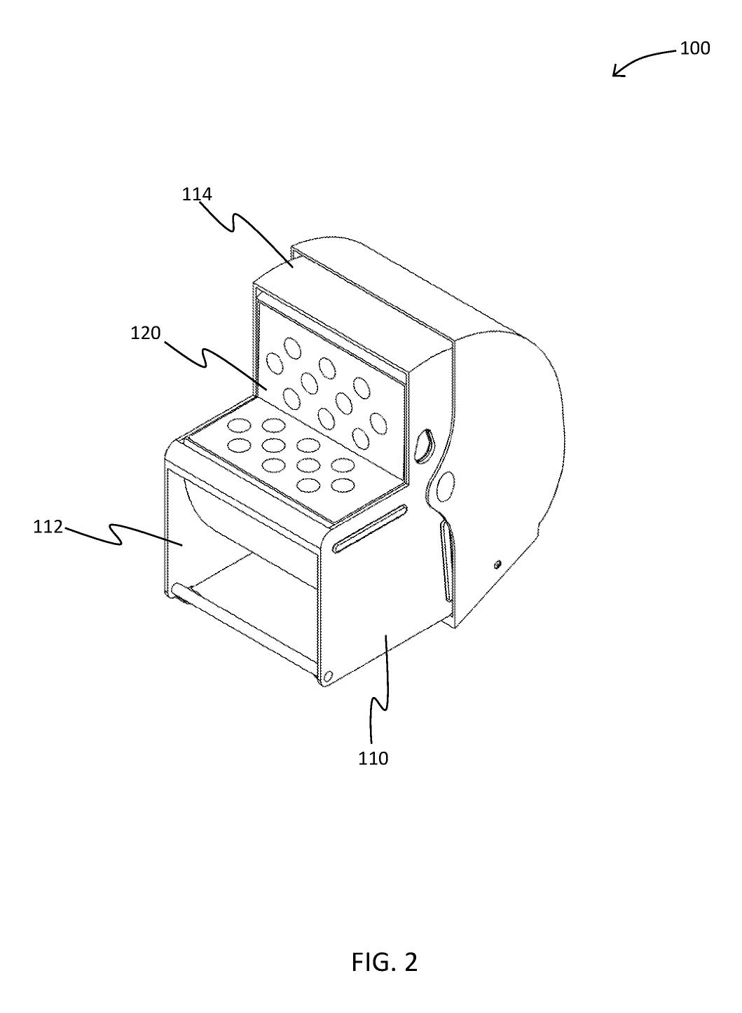

Referring now to FIG. 2 showing a front-side perspective view of the device 100 of FIG. 1, according to an embodiment of the present disclosure. Illustrated here is the housing 110 of the device 100 including the test-member 120. The housing 110 may include an inner-capacity 112 and an outer-shell 114 having a substantially open-portion 116 and as shown, the test-member 120 may disposed within the inner-capacity 112 of the housing 110 and hingedly-connected to the housing 110.

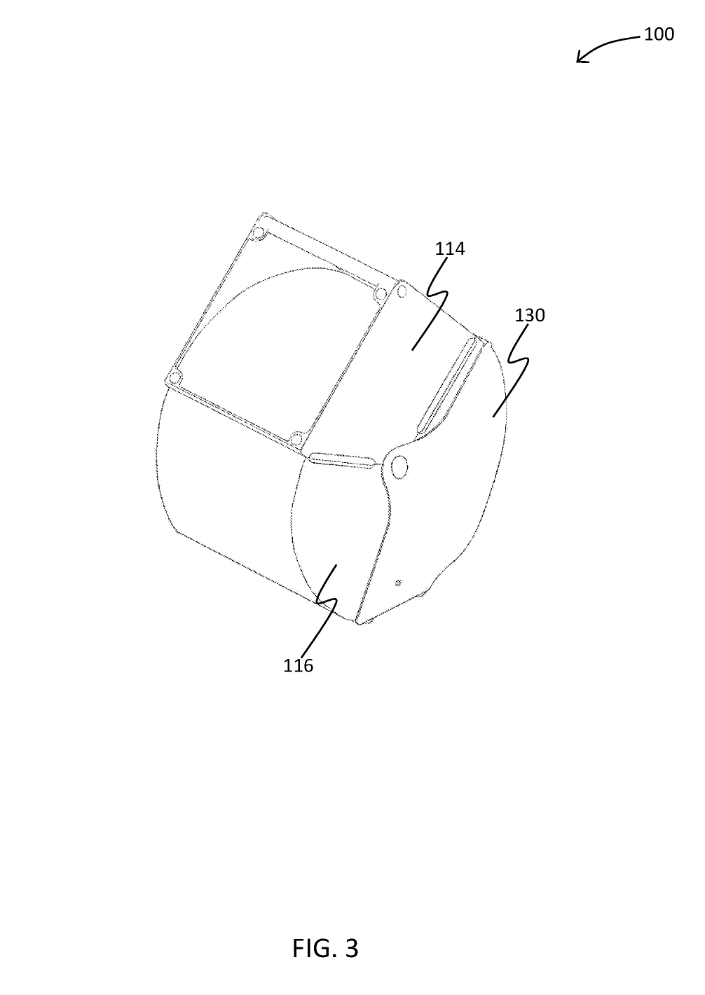

FIG. 3 shows a bottom perspective view of the device 100 of FIG. 1, according to an embodiment of the present disclosure. Illustrated here is the housing 100 as above and the cover-portion 130. As shown, the cover-portion 130 may be hingedly-connected to the outer-shell 114 of the housing 110 and configured to selectively cover the substantially open-portion 116 (FIG. 2). As illustrated, the housing 110 may include a substantially square-shaped bottom. Further, the substantially square-shaped bottom may include at least four non-slip members attached thereto configured to grip a surface and prevent slippage of the device 100 from the surface.

Referring now to FIG. 4 showing a front-side perspective view of the device 100 of FIG. 1, according to an embodiment of the present disclosure. Illustrated here is the test-member 120. As shown, the test-member 120 may include at least two test-displays 122 opposite each other, one of the at least two test-displays 122 including a first development topic 124 and another one of the at least two test-displays 122 including a second development topic 126, and wherein the test-member 120 is configured to selectively revolve between the at least two test-displays 122 such that the user 40 (FIG. 1) may view a selected test-display 122 through the substantially open-portion 116 (FIG. 2).

As shown, the device 100 may further include the plurality of test-blocks 140. The plurality of test-blocks 140 may include a set of first test-blocks 141 including the first development topic 124 and configured for use with the one of the at least two test-displays 122, and a set of second test-blocks 142 including the second development topic 126 and configured for use with the another one of the at least two test-displays 122.

Further, as illustrated, the test-member 120 may include a star shape including at least five-arms 117. In this embodiment, the at least two test-displays 122 may be at least five test-displays 122 and each of the five test-displays 122 may include a different development topic. Further, each test-display may include a test-block holding-portion 143 and a test-block receiving-portion 145; the test-block holding-portion 143 may include a plurality of test-block holding-slots 144 configured to hold at least one of the plurality of test-blocks 140, and the test-block receiving-portion 145 may include plurality of test-block receiving-apertures 146 is configured to receive the at least one of the plurality of test-blocks 140. In the star-shaped embodiment, each arm of the at least five-arms 117 may include the test-block holding portion and the test-block receiving-portion 145 opposite each other.

Each arm of the at least five-arms 117 may include an inner-cavity 118 configured to store the plurality of test-blocks 140 when received via the test-block receiving-portion 145, and each of the test-block receiving-portions 145 may further include an extraction-hole 119 configured to permit removal of the plurality of test-blocks 140 from the inner-cavity 118. In addition to this, the selected test-display may include the test-block holding-portion 143 in a flat-horizontal configuration, and the test-block receiving-portion 145 in a flat-vertical configuration. In this embodiment, the test-block holding-portion 143 in the flat-horizontal configuration and the test-block receiving-portion 145 in the flat-vertical configuration may couplable together in an L-shape configuration.

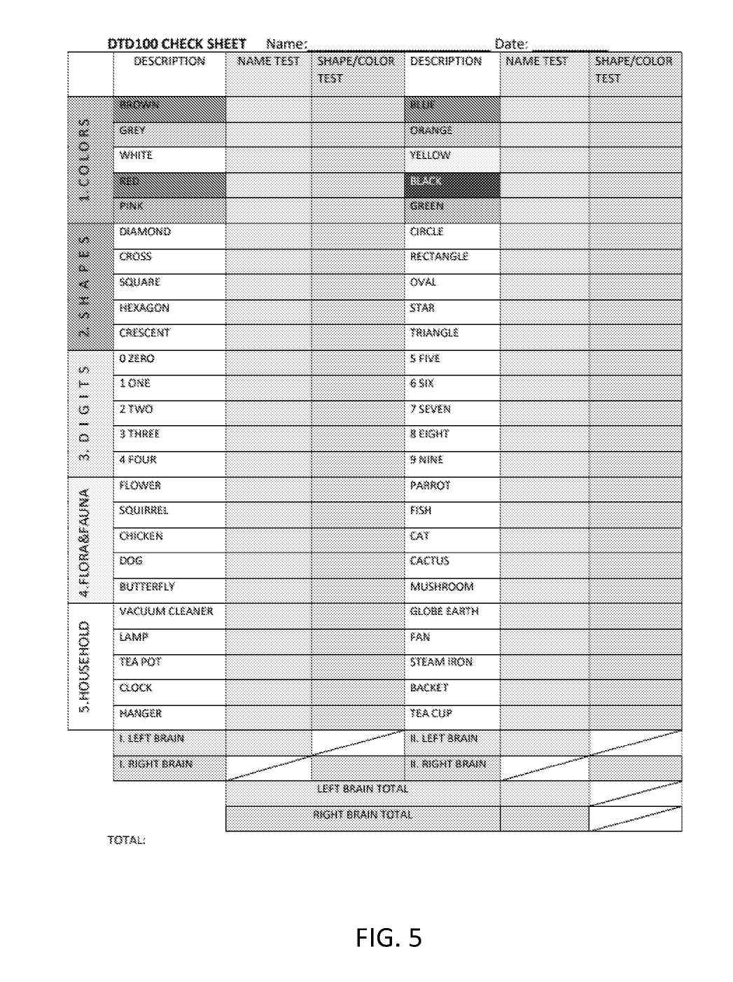

Referring now to FIG. 5 showing a check list according to an embodiment of the present disclosure. The check list may include the different topics as above. The different topics may include colors; shapes; digits; flora and fauna; and household. The checklist may allow the tester to test the testable using the DTD with marks from 0-100. This may help the tester to digitize testable knowledge. As shown, each topic may include a 20-point maximum equaling a maximum of 100 points for the entire test.

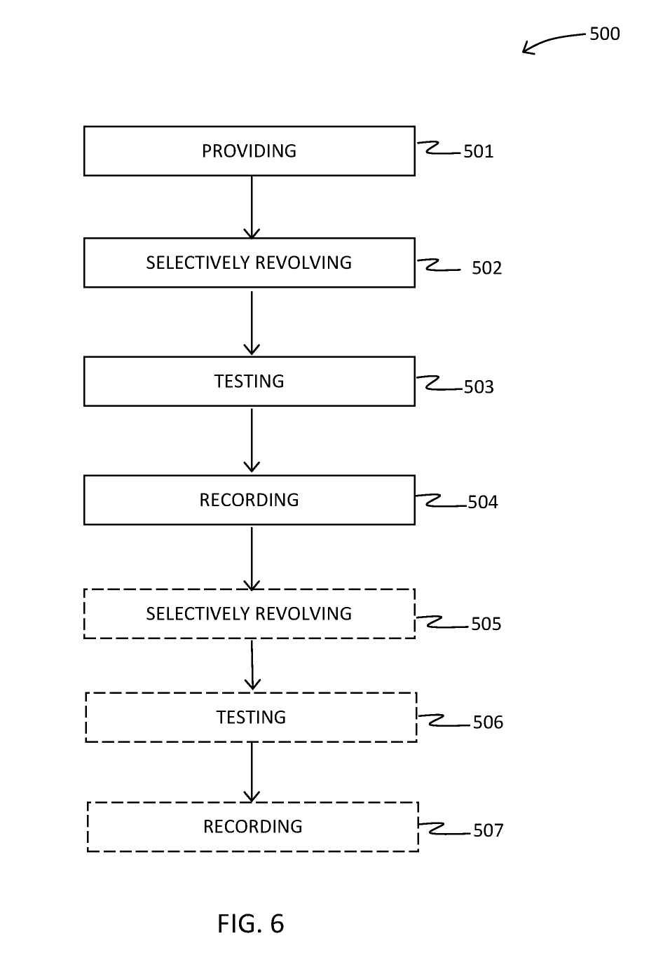

Referring now to FIG. 6, a flow diagram illustrating a method of using a device for testing cognitive development of a user 500, according to an embodiment of the present disclosure. As illustrated, the method of using a device for testing cognitive development of a user 500 may include the steps of: step one 501, providing the device 100 as above; step two 502, selectively revolving the test-member 120 to view one of the at least two test-displays 122, the one of the at least two test-displays 122 including one of the first development topic 124 and the second development topic 126; step three 503, testing the user 40 on the one of the first development topic 124 and the second development topic 126; and step four 504, recording a result of the test. Further steps may include: step five 505, selectively revolving the test-member 120 to view another one of the at least two test-displays 122, the another one of the at least two test-displays 122 including another one of the first development topic 124 and the second development topic 126; step six 506, testing the user 40 on the another one of the first development topic 124 and the second development topic 126; and step seven 507, recording the result of the test.

It should be noted that step five 505, step six 506, and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for testing cognitive development of a user, the device comprising:
a housing including an inner-capacity and an outer-shell, the outer-shell having a substantially open-portion; and
a test-member disposed within the inner-capacity of the housing and hingedly-connected to the housing, the test-member including at least two test-displays opposite each other, one of the at least two test-displays including a first development topic and another one of the at least two test-displays including a second development topic, and wherein the test-member is configured to selectively revolve between the at least two test-displays such that the user may view a selected test-display through the substantially open-portion.

2. The device of claim 1, further comprising a cover-portion hingedly-connected to the outer-shell of the housing and configured to selectively cover the substantially open-portion.

3. The device of claim 1, wherein the test-member includes a star shape including at least five-arms.

4. The device of claim 1, further comprising a plurality of test-blocks.

5. The device of claim 3, wherein the at least two test-displays are at least five test-displays.

6. The device of claim 5, wherein each of the five test-displays includes a different development topic.

7. The device of claim 4, wherein the plurality of test-blocks includes a set of first test-blocks including the first development topic and configured for use with the one of the at least two test-displays.

8. The device of claim 7, wherein the plurality of test-blocks further includes a set of second test-blocks including the second development topic and configured for use with the another one of the at least two test-displays.

9. The device of claim 6, wherein each test-display includes a test-block holding-portion and a test-block receiving-portion.

10. The device of claim 9, wherein the test-block holding-portion includes a plurality of test-block holding-slots configured to hold at least one of the plurality of test-blocks.

11. The device of claim 10, wherein the test-block receiving-portion a plurality of test-block receiving-apertures is configured to receive the at least one of the plurality of test-blocks.

12. The device of claim 9, wherein the selected test-display includes the test-block holding-portion in a flat-horizontal configuration, and the test-block receiving-portion in a flat-vertical configuration.

13. The device of claim 12, wherein the test-block holding-portion in the flat-horizontal configuration and the test-block receiving-portion in the flat-vertical configuration are couplable together in an L-shape configuration.

14. The device of claim 9, wherein each arm of the at least five-arms includes the test-block holding portion and the test-block receiving-portion opposite each other.

15. The device of claim 14, wherein each said arm of the at least five-arms includes an inner-cavity configured to store the plurality of test-blocks when received via the test-block receiving-portion.

16. The device of claim 15, wherein each of the test-block receiving-portions further include an extraction-hole configured to permit removal of the plurality of test-blocks from the inner-cavity.

17. A device for testing cognitive development of a user, the device comprising:
a housing including an inner-capacity and an outer-shell, the outer-shell having a substantially open-portion;
a test-member disposed within the inner-capacity of the housing and hingedly-connected to the housing, the test-member including at least two test-displays opposite each other, one of the at least two test-displays including a first development topic and another one of the at least two test-displays including a second development topic, and wherein the test-member is configured to selectively revolve between the at least two test-displays such that the user may view a selected test-display through the substantially open-portion;
a cover-portion hingedly-connected to the outer-shell of the housing and configured to selectively cover the substantially open-portion;
a plurality of test-blocks; and
wherein the test-member includes a star shape including at least five-arms;
wherein the at least two test-displays are at least five test-displays;
wherein each of the five test-displays includes a different development topic;
wherein the plurality of test-blocks includes a set of first test-blocks including the first development topic and configured for use with the one of the at least two test-displays;
wherein the plurality of test-blocks includes a set of first test-blocks including the first development topic and configured for use with the one of the at least two test-displays;
wherein each test-display includes a test-block holding-portion and a test-block receiving-portion;
wherein the test-block holding-portion includes a plurality of test-block holding-slots configured to hold at least one of the plurality of test-blocks;
wherein the test-block receiving-portion includes a plurality of test-block receiving-apertures is configured to receive the at least one of the plurality of test-blocks;
wherein the selected test-display includes the test-block holding-portion in a flat-horizontal configuration, and the test-block receiving-portion in a flat-vertical configuration;
wherein the test-block holding-portion in the flat-horizontal configuration and the test-block receiving-portion in the flat-vertical configuration are couplable together in an L-shape configuration;
wherein each arm of the at least five-arms includes the test-block holding portion and the test-block receiving-portion opposite each other;
wherein each said arm of the at least five-arms includes an inner-cavity configured to store the plurality of test-blocks when received via the test-block receiving-portion; and
wherein each of the test-block receiving-portions further include an extraction-hole configured to permit removal of the plurality of test-blocks from the inner-cavity.

18. The device of claim 17, further comprising set of instructions; and
wherein the device is arranged as a kit.

19. A method of using a device for testing cognitive development of a user, the method comprising the steps of:
providing the device for testing cognitive development of the user, the device including:
a housing including an inner-capacity and an outer-shell, the outer-shell having a substantially open-portion; and
a test-member disposed within the inner-capacity of the housing and hingedly-connected to the housing, the test-member including at least two test-displays opposite each other, one of the at least two test-displays including a first development topic and another one of the at least two test-displays including a second development topic, and wherein the test-member is configured to selectively revolve between the at least two test-displays such that the user may view a selected test-display through the substantially open-portion;
selectively revolving the test-member to view one of the at least two test-displays, the one of the at least two test-displays including one of the first development topic and the second development topic;
testing the user on the one of the first development topic and the second development topic; and
recording a result of the test.

20. The method of claim 19, further comprising the steps of:
selectively revolving the test-member to view another one of the at least two test-displays, the another one of the at least two test-displays including another one of the first development topic and the second development topic;
testing the user on the another one of the first development topic and the second development topic; and
recording the result of the test.
